(19) United States
(12) Patent Application Publication
(10) Pub. No.: US 2015/0135642 A1
(43) Pub. Date: May 21, 2015

(54) SHEET BONDING DEVICE AND ENCLOSING-SEALING DEVICE

(71) Applicant: RISO KAGAKU CORPORATION, Tokyo (JP)

(72) Inventors: Yoshihiro NAKAMURA, Tokyo (JP); Tadayuki WAKATABI, Tokyo (JP); Atsushi HIROSHIMA, Minato-ku, Tokyo (JP)

(21) Appl. No.: 14/540,593

(22) Filed: Nov. 13, 2014

(30) Foreign Application Priority Data
Nov. 19, 2013 (JP) 2013-239026
Aug. 18, 2014 (JP) 2014-166033

(51) Int. Cl. B31B 1/62; B43M 5/04

(52) U.S. Cl. CPC B31B 1/62; B43M 5/047
USPC 53/377.4; 156/349; 156/441.5

(57) ABSTRACT

A glue application unit applies glue to glue application region of an envelope form to form main adhesive part with a required thickness that allows firm adhesion between glue application region and counter region after the sheet adhesion process, and a temporary adhesive part with a thickness thinner than the main adhesive part for temporarily adhering the glue application region and the counter region within a short period of time. A predetermined pressure is applied to the glue application region and the counter region which are in contact with each other on the envelope form having a content enclosed so that those regions are adhered by the sheet bonding unit.

### TECHNICAL FIELD

The present invention relates to a sheet bonding device configured to apply glue to predetermined area on a sheet of paper, and press-fit glue application region of the sheet and counter region of the sheet which are in contact with each other so as to be adhered together, and an enclosing-sealing device configured to enclose contents in an envelope form glued with the sheet bonding device, and seal the envelope.

### BACKGROUND OF ART

Japanese Published Unexamined Patent Application No. 2011-121737 discloses the sheet gluing device which includes the first conveyance unit provided with the first adhesive application mechanism for applying the adhesive to both ends of the sheet in a direction orthogonal to the first conveyance direction, and the first perforation drilling mechanism for performing the perforation process on the sheet inward from the position to which the adhesive is applied by the first adhesive application mechanism, and the second conveyance unit to convey in the second conveyance direction provided with the opening mechanism for opening the folded sheet in the vertical direction, the second adhesive application mechanism for applying the adhesive to the open end of the sheet parallel to the second conveyance direction orthogonal to the first conveyance direction, and the sealing mechanism for overlapping the upper folded part and the lower folded part of the sheet so as to be adhered together. The sheet is folded in two, three or more, and the adhesive is applied to the adhesive application position for sealing.

### SUMMARY OF INVENTION

### Technical Problem

The applicants of the present invention have been engaged in research and development of the enclosing-sealing device configured to enclose contents in a envelope formed by folding a commercial envelope form to which compression glue or remoistening glue is preliminarily applied, and to seal the envelope. They have set to work on development of the enclosing-sealing device configured to use a commercial sheet of paper (hereinafter simply referred to as the sheet) having a predetermined area to which glue is applied as a envelope form. Upon start of development of the new device, use of the sheet to which glue is applied as a envelope has revealed problems as below.

### (Problem 1)

If the amount of glue to be applied to a sheet is increased (that is, thickly applied), a large amount of glue secures firm adhesive strength after the finished product is obtained. Therefore, the adhesive part is not peeled off by impact during transportation. However, the large amount of applied glue prolongs the time for development of the adhesion force. The adhesive part may be peeled off immediately after adhesion of the sheet by bulge of the folded content and restoring force of the folded part.

### (Problem 2)

If the amount of glue to be applied to a sheet is reduced (that is, thinly applied), the small amount of glue shortens the time for development of the adhesive force. Therefore, the adhesive part is unlikely to be peeled off by the bulge of the folded content and restoring force of the folded part immediately after the sheet adhesion process. However, the small amount of applied glue fails to impart sufficient adhesive strength to the finished product. The adhesive part may be peeled off by impact during transportation.

In the case where glue is applied to the sheet using the known glue application device as disclosed in Japanese Published Unexamined Patent Application No. 2011-121737, it is applied to have substantially uniform height with a few errors at the corner of the glue surface owing to surface tension in a cross-sectional view orthogonal to the glue application direction as shown in FIG. 16. Even if the amount of glue to be applied is adjusted, it is highly likely to cause the aforementioned problems immediately after the sheet bonding process, resulting in the sealing failure.

It is an object of the present invention to provide a sheet bonding device configured to apply glue to a sheet so as to secure adhesive strength to withstand impact during transportation while preventing peeling off the adhesive part, resulting from bulge of the content through development of the adhesive force within a short period of time, and the enclosing-sealing device for enclosing the content in the envelope form glued with the device and sealing the resultant envelope.

### Solution for Problem

To address the above problems, according to a first aspect of the present invention, the sheet bonding device includes:

a glue application unit for applying glue to glue application region of a sheet; and

a sheet bonding unit for adhering the glue application region to which glue is applied and counter region to be adhered to the glue application region, which are in contact with each other through application of a predetermined pressure.

The glue application unit applies glue to the glue application region of the sheet to form main adhesive part having a thickness which ensures to keep an adhesive state between the glue application region and the counter region after an adhesion process performed by the sheet bonding unit, as well as temporary adhesive part having a thickness thinner than the thickness of the main adhesive part for temporary adhesion.

According to a second aspect of the present invention, in the sheet bonding device according to the first aspect, the glue application unit forms the temporary adhesive part, which has a thickness half or smaller than the thickness of the main adhesive part, at a position away more than distance corresponding to the thickness of the main adhesive part, which is measured at immediately after applying the glue, from an application position of the main adhesive part.

According to a third aspect of the present invention, in the sheet bonding device according to the first aspect, the glue application unit includes a glue application roller with an application groove formed to allow each of the main adhesive part and the temporary adhesive part to have a predetermined thickness upon application of glue to the glue application region of the sheet.

According to a fourth aspect of the present invention, in the sheet bonding device according to the second aspect, the glue application unit includes a glue application roller with an application groove formed to allow each of the main adhesive part and the temporary adhesive part to have a predetermined thickness upon application of glue to the glue application region of the sheet.

According to a fifth aspect of the present invention, in the sheet bonding device according to according to the first aspect, the glue application unit includes a first dispenser for forming the main adhesive part, a second dispenser for forming the temporary adhesive part, and a control unit for controlling glue application operations of the first and the second dispensers.

According to a sixth aspect of the present invention, in the sheet bonding device according to according to the second aspect, the glue application unit includes a first dispenser for forming the main adhesive part, a second dispenser for forming the temporary adhesive part, and a control unit for controlling glue application operations of the first and the second dispensers.

According to a seventh aspect of the present invention, an enclosing-sealing device uses the sheet bonding device according to the first aspect for applying glue to glue application region of an envelope form and manufacturing a sealed matter by adhering the glue application region with counter region of the envelope form while having a content enclosed with the envelope form to which the glue is applied, and sealing the envelope form.

The temporary adhesive part is formed to have a belt-like configuration shorter than the main adhesive part, and has its application position and total number of applications controlled in accordance with a thickness of the sealed matter.

According to a eighth aspect of the present invention, an enclosing-sealing device uses the sheet bonding device according to the second aspect for applying glue to glue application region of an envelope form and manufacturing a sealed matter by adhering the glue application region with counter region of the envelope form while having a content enclosed with the envelope form to which the glue is applied, and sealing the envelope form.

The temporary adhesive part is formed to have a belt-like configuration shorter than the main adhesive part, and has its application position and total number of applications controlled in accordance with a thickness of the sealed matter.

According to a ninth aspect of the present invention, an enclosing-sealing device uses the sheet bonding device according to the fifth aspect for applying glue to glue application region of an envelope form and manufacturing a sealed matter by adhering the glue application region with counter region of the envelope form while having a content enclosed with the envelope form to which the glue is applied, and sealing the envelope form.

The temporary adhesive part is formed to have a belt-like configuration shorter than the main adhesive part, and has its application position and total number of applications controlled in accordance with a thickness of the sealed matter.

According to a tenth aspect of the present invention, an enclosing-sealing device uses the sheet bonding device according to the sixth aspect for applying glue to glue application region of an envelope form and manufacturing a sealed matter by adhering the glue application region with counter region of the envelope form while having a content enclosed with the envelope form to which the glue is applied, and sealing the envelope form.

The temporary adhesive part is formed to have a belt-like configuration shorter than the main adhesive part, and has its application position and total number of applications controlled in accordance with a thickness of the sealed matter.

### Advantageous Effects of Invention

The sheet bonding device according to claim 1 allows the glue application unit to apply glue to the glue application region on the sheet so that the thickness differs among applied glues. When the sheet bonding unit performs the sheet bonding process through press-fitting, the temporary adhesive part temporarily adheres within a short period immediately after the sheet bonding process to prevent peeling off the adhesive part, resulting from bulge of the content and restoring force of the folded part, and the main adhesive part firmly adheres to impart the adhesive strength to the finished product after the sheet bonding process, which is sufficient to withstand impact during transportation.

The sheet bonding device according to claim 2 is configured to apply glue to form the temporary adhesive part, at a position away more than distance corresponding to the thickness of the main adhesive part, which is measured at immediately after applying the glue, from an application position of the main adhesive part.

This makes it possible to impart the adhesive force to the temporary adhesive part immediately upon adhesion between the glue application region and the counter region through press-fitting while preventing glue applied to form the main adhesive part from reaching the temporary adhesive part.

The sheet bonding device according to claim 3 or 4 is configured to apply glue using a glue application roller with a glue application groove so that each of the main adhesive part and the temporary adhesive part in the glue application region of the envelope form has a predetermined thickness. Once the glue application configuration is set, and the application groove is formed on the glue application roller, it is possible to stably apply glue to the glue application region with the desired application configuration without requiring the complicated control.

The sheet bonding device according to claim 5 or 6 is configured to apply glue using the dispenser to form the main adhesive part and the temporary adhesive part in a glue application region of a envelope form. It is therefore possible to easily apply glue to form arbitrary numbers of the main adhesive parts and the temporary adhesive parts at arbitrary positions in the glue application region.

The enclosing-sealing device according to any one of claims 7 to 10 is configured to apply glue to form required number of the temporary adhesive parts at the position corresponding to the thick part with the bulge of the folded part of the content. This makes it possible to perform the sealed letter manufacturing process which ensures to prevent peeling off the adhesive part, resulting from the thick part of the content after the sealing process.

It is also possible to apply glue to form the temporary adhesive part at the appropriate position in accordance with the thickness of the content defined by the number of sheets and fold type of the content, thus saving a consumption amount of glue.

### BRIEF DESCRIPTION OF DRAWINGS

FIG. 1 is a schematic view illustrating the structure of a sealed letter manufacturing apparatus in which a roller type sheet bonding device according to the present invention is installed;

FIGS. 2A and 2B are explanatory views of an envelope form used in the device, and an application configuration of glue, wherein FIG. 2A is a plan view, and FIG. 2B is a front view;

FIG. 3A illustrates an application state immediately after thin application (coating thickness: 0.03 mm) of the W/O emulsion type adhesive;

FIG. 3B illustrates the state of the sheet press-fitted from the application state shown in FIG. 3A; FIG. 3C illustrates the application state immediately after thick application (coating thickness: 0.1 mm) of the W/O emulsion type adhesive;

FIG. 3D illustrates the state of the sheet press-fitted from the application state as shown in FIG. 3C;

FIG. 4 is a schematic view illustrating the structure of the sheet bonding device in a side view;

FIG. 5 is a schematic view illustrating the structure of the sheet bonding device in planar view;

FIG. 6 is a functional block diagram of the sheet bonding device;

FIGS. 7A to 7F conceptually illustrate examples of an application configuration of glue applied to the sheet;

FIGS. 8A to 8G illustrate varied configurations of applied glue and state of adhesion in the sheet bonding process;

FIG. 9 is a schematic view illustrating the structure of a sealed letter manufacturing apparatus in which a dispenser type sheet bonding device according to the present invention is installed;

FIG. 10 is a perspective view illustrating an exemplary structure of a dispenser type glue application unit;

FIG. 11 is a view illustrating an example of an application position of a temporary adhesive part on an envelope form;

FIG. 12A shows an example of a temporary application region table representing application positions of the temporary adhesive part, which are defined by the number of sheets and the fold type of the relatively thin content;

FIG. 12B shows an example of the temporary application region table representing application positions of the temporary adhesive part, which are defined by the number of sheets and the fold type of the relatively thick content;

FIG. 13A is a sectional view of a sealed letter formed by enclosing three sheets of the content folded in two;

FIG. 13B is a plan view illustrating the application states of the main adhesive part and the temporary adhesive part for manufacturing the sealed letter as shown in FIG. 13A;

FIG. 14A is a sectional view of a sealed letter formed by enclosing three sheets of the content inner folded in three;

FIG. 14B is a plan view illustrating the application states of the main adhesive part and the temporary adhesive part for manufacturing the sealed letter as shown in FIG. 14A;

FIGS. 15A and 15B are views illustrating examples of application states of the main adhesive part and the temporary adhesive part, wherein FIG. 15A illustrates the application surface of the main adhesive part with a belt-like cut part, and FIG. 15B illustrates the application surface of the main adhesive part with two recess-like parts; and

FIG. 16 illustrates a cross section of the application configuration of glue applied by the generally employed device.

### DESCRIPTION OF EMBODIMENTS

Embodiments of the present invention will be described in detail referring to the drawings. It is to be noted that the present invention is not limited to the embodiments described below. The scope of the present invention covers any possible embodiments, examples and operation technology which those skilled in the art think of.

A sheet bonding device 1 according to the present invention uses a sheet with a positioned glue application region PA to which glue A is applied (hereinafter referred to as “envelope form PE”) for forming an envelope, and a sheet as the content P enclosed in the envelope formed by folding the envelope form PE in the predetermined manner. Each of those sheets is a commercial sheet of paper (hereinafter simply referred to as “sheet”).

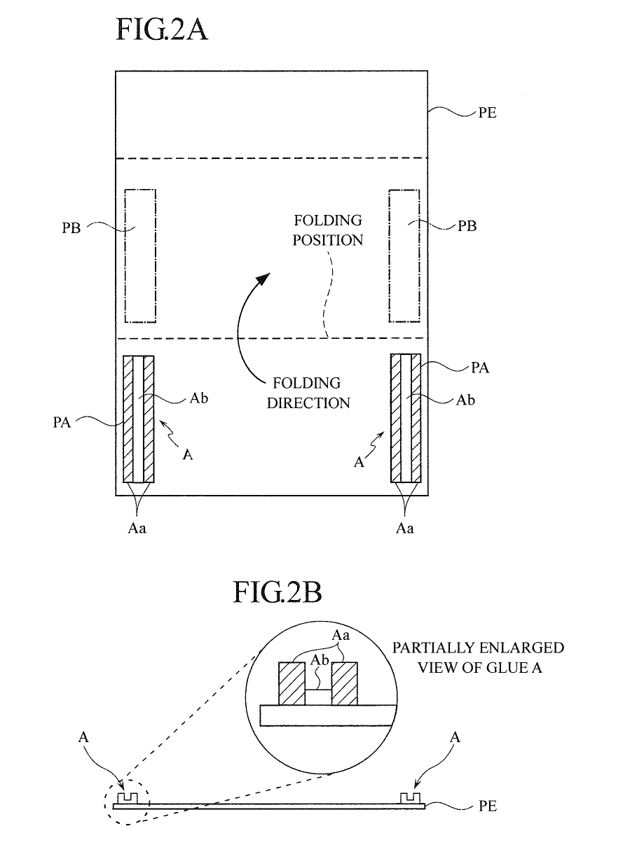

Referring to FIG. 2A or FIG. 2B, the glue A is applied to the glue application region PA of the envelope form PE by a glue application unit 123 to be described below. Specifically, the glue is applied to form a “main adhesive part Aa” where it is applied with the thickness (amount) required to establish the main adhesion between the glue application region PA and counter region PB after the sheet bonding process (that is, keeping the adhesive state where the adhesive part between the glue application region PA and the counter region PB (hereinafter simply referred to as “adhesive part”) is not peeled by impact during transportation of the envelope as the finished product), and a “temporary adhesive part Ab” where it is applied with the thickness smaller than the main adhesive part Aa by a predetermined height so that the glue application region PA and the counter region PB are temporarily adhered within a short period of time immediately after the sheet bonding process (that is, keeping the adhesive state where the adhesive part is not peeled by the bulge of the content P or restoring force of the folded part immediately after the sheet bonding process although the resultant envelope as the finished product cannot withstand impact during transportation).

The “glue” to be used in the present invention is a liquid glue with such properties as dry hardiness unlikely to be dried in the state where the solute that keeps the adhesive force before application is dispersed in the solvent, development of adhesive force that exhibits the adhesive force of the solute under a predetermined pressure through evaporation of the solvent or absorption in the sheet and drying, and viscosity to the degree sufficient to keep the predetermined thickness and configuration of the glue applied to the sheet. It is preferable to use the emulsion type adhesive, and more preferable to use the W/O emulsion type adhesive. The applicants have filed applications for the present invention concerning the W/O emulsion type adhesive (Japanese Published Unexamined Patent Application Nos. 2014-47219, 2013-127037, and 2013-127036). The double emulsion type adhesive as disclosed in Japanese Published Unexamined Patent Application No. 2013-237818 is also usable as the adhesive in the present invention.

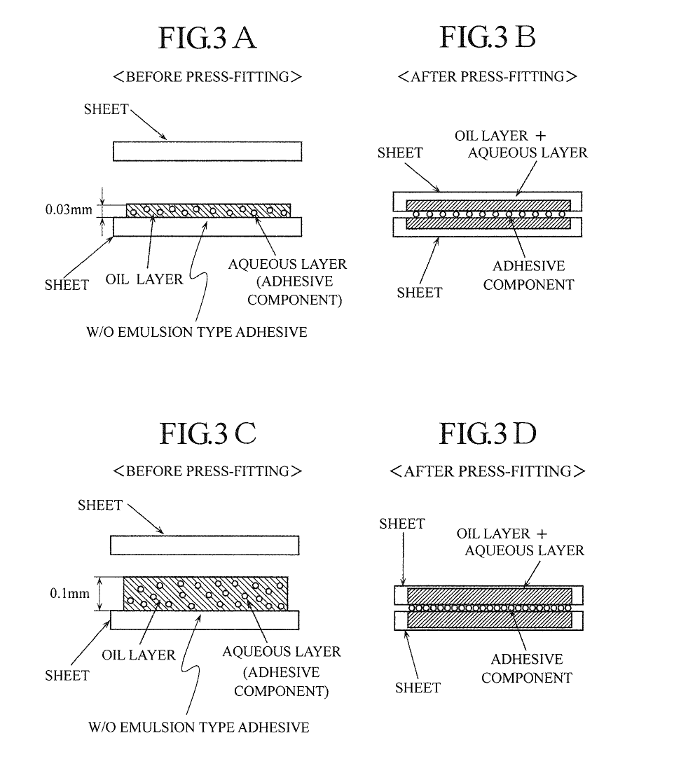

Each of FIGS. 3A to 3D illustrates about the state change of the W/O emulsion type adhesive. FIGS. 3A and 3B show the thin application state, and FIGS. 3C and 3D show the thick application state. The W/O emulsion type adhesive has an aqueous layer as the adhesive component within an oil layer. The oil layer permeates the sheet so as to bring the adhesive component into direct contact with the sheet for adhesion. The particle size of the aqueous layer is set to be larger than the interval of fiber of the sheet. Press-fitting promotes permeation of the oil layer into the sheet. Meanwhile, the adhesive component that remains on the sheet surface quickly dries.

As FIGS. 3A and 3B show, the volume of the gap between fibers of a sheet is sufficiently larger than the volume of the oil layer (that is, thin application), the oil layer mostly permeates the sheet to complete the adhesion within a short period. Since the adhesive force is proportional to the adhesive amount, such amount is insufficient to realize the firm adhesion. On the contrary, as FIGS. 3C and 3D show, the volume of the gap between fibers of a sheets is comparable to that of the oil layer (that is, thick application), it takes time for the oil layer to permeate the sheet, thus requiring long time for adhesion. However, firm adhesive force may be derived from a large amount of the adhesive. As described above, it is preferable to set the thickness of the glue of the thin application part formed as the temporary adhesive part Ab to be half or smaller than the thickness of the glue of the thick application part formed as the main adhesive part Aa, which is measured at immediately after application of the glue A to the sheet. If the thickness of the glue A is increased excessively, it is difficult to realize the temporary adhesion within the short period of time, thus failing to provide the expected effect. The device according to the present invention applies the glue A so that the thickness of the temporary adhesive part Ab becomes half or thinner than the thickness of the main adhesive part Aa.

### [Sealed Letter Manufacturing Apparatus}

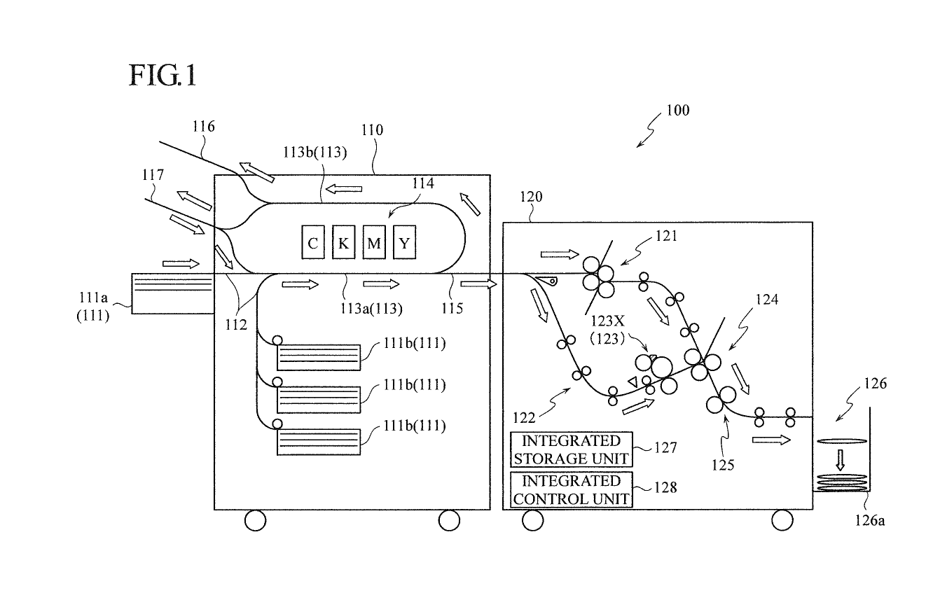

A sealed letter manufacturing apparatus 100 in which the sheet bonding device 1 according to the present invention is installed will be described. As FIG. 1 illustrates, the sealed letter manufacturing apparatus 100 includes a printing unit (printer) 110 which executes the predetermined printing process on the sheet which is the content P of the sealed letter or on the envelope form PE which encloses the content P, and an enclosing-sealing unit 120 (enclosing-sealing device) which encloses the content P with the envelope form PE in the enfolding manner after folding the content P and the envelope form PE printed by the printing unit 110 in the predetermined manner and seals the envelope form PE to manufacture the sealed letter.

### <Printing Unit>

The printing unit 110 is configured to perform predetermined printing on the envelope form PE and the content P, and to discharge the printed sheet to the enclosing-sealing unit 120 in the subsequent stage.

The printing unit 110 includes a sheet feeder 111 which feeds various kinds of sheets stacked on sheet feed trays 111b inside the housing, or a sheet feed plate 111a at the side of the housing (sheets, such as the content P or the envelope form PE) at predetermined timing, a conveyance path 113 which includes a first conveyance path 113a for horizontally conveying the sheet fed from introducing passage 112 and a closed loop second conveyance path 113b on which the content P is conveyed for both-side printing via the first conveyance path 113a, a printing unit 114 for performing printing on the content P conveyed through the conveyance path 113, a first discharge passage 115 for discharging the content P into the enclosing-sealing unit 120, a second discharge passage 116 for discharging the content P which has been conveyed through the second conveyance path 113b to the outside the housing, and a switchback passage 117 for reversing the direction for feeding the received content P that has been conveyed through the second conveyance path 113b to reverse its front and rear surfaces by returning the content P to the first conveyance path 113a again.

### <Enclosing-Sealing Unit>

The enclosing-sealing unit 120 is configured to subject the respective sheets to be formed as the envelope form PE and the content P in the folding process, and execute the enclosing-sealing process by enclosing the content P with the envelope form PE in an enfolding manner for manufacturing the sealed letter. The device of this embodiment is configured to fold the envelope form PE in three so as to enclose the content P in the enfolding manner. However, there are various variation of the number of folds and the fold type of the envelope form depending on the shape and usage of the finished product to be manufactured, the number of folds and the fold type of the envelope form PE may be arbitrarily set without being limited to the embodiments described herein.

More specifically, the enclosing-sealing unit 120 includes a content folding unit 121 provided with a plurality of folding rollers for making predetermined folds as necessary while conveying the sheet to be formed as the content P along the conveyance path for content, a sheet conveyance unit 122 for conveying the sheet to be formed as the envelope form PE along the conveyance path for envelope form, a glue application unit 123 for applying the required amount of glue A to the glue application region PA on the envelope form PE (corresponding to the roller type glue application unit 123X in the drawing), a container unit 124 for storing the content P in the enfolding manner while folding a part of the envelope form PE during conveyance, a sheet bonding unit 125 for subjecting the glue application region PA and the counter region PB of the envelope form PE which are in contact with each other to the sheet bonding process through press-fitting during conveyance for sealing the envelope, and a discharge unit 126 for conveying the sealed letter subjected to the sealing process so as to be discharged to a discharge tray 126a outside the housing of the unit.

The sealed letter manufacturing apparatus 100 also includes an integrated storage unit (storage unit) 127 which stores information required to drive the respective components of the sealed letter manufacturing apparatus 100, and an integrated control unit (control unit) 128 which controls the driving of the respective components of the sealed letter manufacturing apparatus 100.

The sealed letter manufacturing job contains the information required for manufacturing the sealed letter, for example, the number of the sealed letters to be manufactured, the envelope information concerning the envelope formed from the envelope form PE (for instance, the number of sheets to be printed, form size, size of the envelope formed from the envelope form PE, printing condition (single-side printing/both-side printing), print image data to be printed, fold type, and the like), and the content information concerning the sheet to be formed as the content P (for instance, the number of sets for printing, the number of sheets of the content, output size, setting of single-side/both-side printing, print image data to be printed, fold type).

The sealed letter manufacturing apparatus 100 obtains the sealed letter manufacturing job through various methods, for example, the method for obtaining the job from the external terminal device operated by the user such as a personal computer, obtaining the job through an auxiliary storage unit that stores the preliminarily set sealed letter manufacturing job such as USB memory, setting the sealed letter manufacturing job through the setting input unit such as various types of input keys and touch panels provided in the main body of the apparatus, and obtaining the job via the communication network from the external server that stores the sealed letter manufacturing job that is set in advance.

The sheet bonding device 1 according to the present invention includes such functions as the “glue application unit 123X” and the “sheet bonding unit 125” of the sealed letter manufacturing apparatus 100. It is configured to apply a predetermined amount of glue A to the glue application region PA of the envelope form PE so as to apply a predetermined pressure to the glue application region PA and the counter region PB of the envelope form PE while contacting each other for enclosing the content P folded in a predetermined manner to perform the sheet bonding process. As a result, the content P is sealed in the envelope.

### [Sheet Bonding Device]

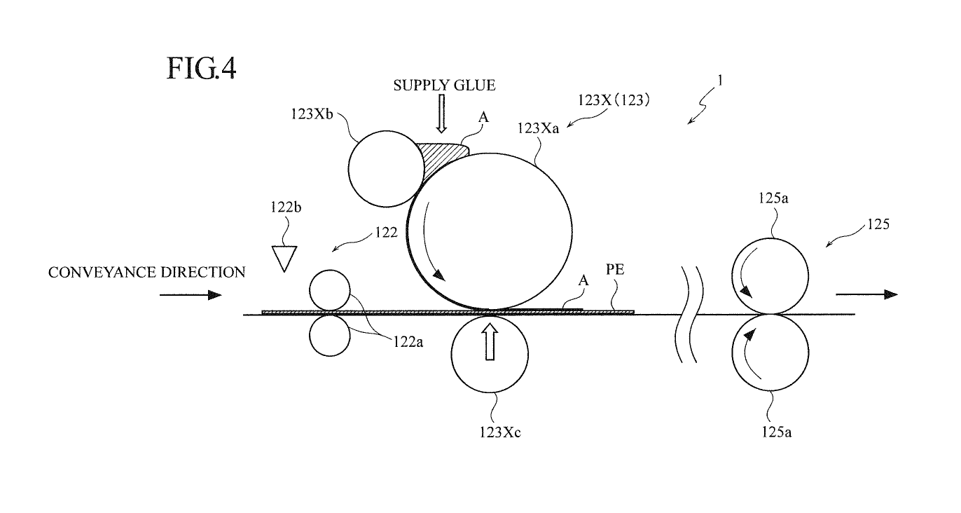

The sheet bonding device 1 according to the present invention will be described referring to FIGS. 4 to 8.

The sheet bonding device 1 of this embodiment is configured to apply the glue A to the glue application region PA of the envelope form PE, and perform the press-fitting process to the glue application region PA and the counter region PB while contacting each other upon conveyance of the envelope form PE that encloses the content P including at least one sheet folded in a predetermined manner for executing the sheet bonding process.

This embodiment takes the device (sheet bonding device) installed in the enclosing-sealing unit 120 as an example so that the container unit 124 executes the process for enfolding the content P with the envelope form PE. The enclosing-sealing unit 120 is described to represent the function of the sheet bonding device installed in the unit. It is possible to use the device separately.

As any of FIGS. 4 to 6 shows, the sheet bonding device 1 includes the sheet conveyance unit 122, the glue application unit 123X, the sheet bonding unit 125, the storage unit 127, and the control unit 128.

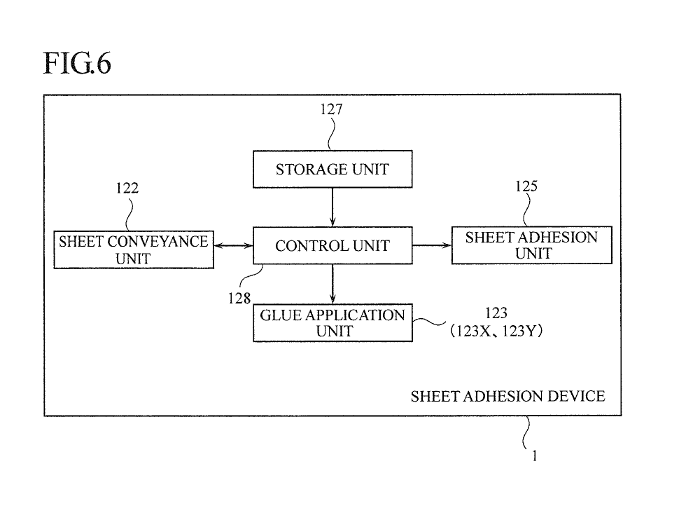

FIGS. 4 and 6 omit the container unit 124 that encloses the content P in the envelope form PE in the enfolding manner, which is disposed between the glue application unit 123X and the sheet bonding unit 125 when the sheet bonding device 1 is installed in the sealed letter manufacturing apparatus 100.

The sheet conveyance unit 122 includes a pair of conveyance rollers 122a for conveying the envelope form PE separated and conveyed from the printing unit 110 in the preceding stage to the glue application unit 123X, and a sheet detection unit 122b for detecting the envelope form PE conveyed from the printing unit 110. The sheet detection unit 122b is composed of an optical sensor such as a photo sensor.

Upon detection of the envelope form PE conveyed from the printing unit 110 under the control of the control unit 128, the sheet conveyance unit 122 outputs a sheet detection signal indicating such detection to the control unit 128 so as to control the driving of the pair of conveyance rollers 122a in synchronization with the glue application timing of the glue application unit 123X for conveying the envelope form PE at the appropriate conveyance timing.

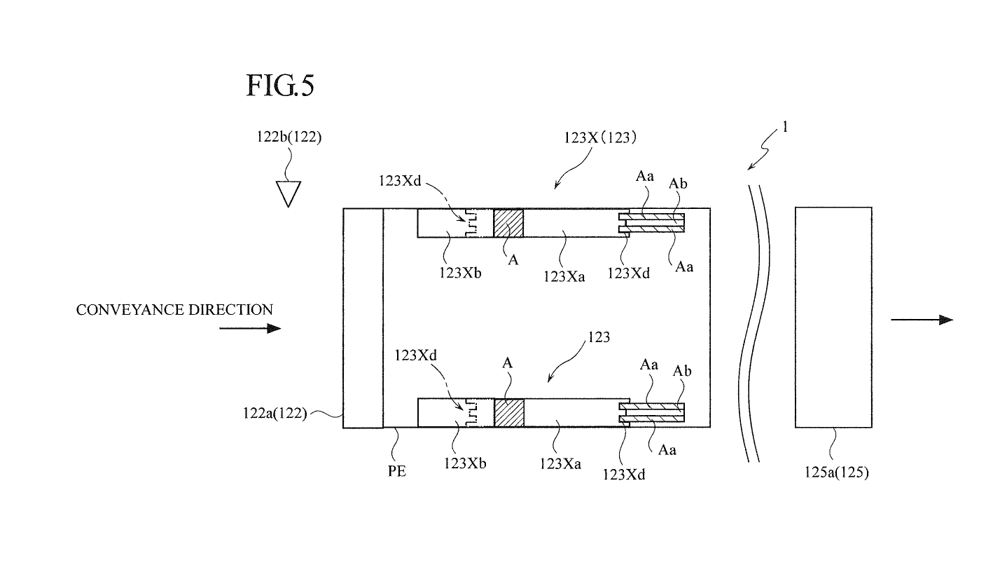

The glue application unit 123X includes a glue application roller 123Xa for applying the glue A to the glue application region PA of the envelope form PE, a supply amount adjustment roller 123Xb disposed with a predetermined gap from the glue application roller 123Xa for holding the constant amount of the glue A to be supplied to the outer peripheral surface of the glue application roller 123Xa, and a press roller 123Xc as the pressure unit that presses the envelope form PE that has been conveyed against the glue application roller 123Xa. In this embodiment, as shown in FIG. 5, the glue application regions PA are formed at two positions at both sides of the envelope form PE in the conveyance direction. Therefore, two sets of combination of the glue application roller 123Xa and the supply amount adjustment roller 123Xb are disposed corresponding to the respective glue application regions PA.

The glue application roller 123Xa has an application groove 123Xd formed at a predetermined position on the outer peripheral surface corresponding to the configuration of the applied glue A so that the glue A applied to the glue application region PA forms the main adhesive part Aa and the temporary adhesive part Ab.

The glue application roller 123Xa of the glue application unit 123X has the application groove 123Xd formed to have the desired glue application configuration, which allows the supply amount adjustment roller 123Xb disposed with a predetermined gap from the glue application roller 123Xa to supply the glue A fed from the not-shown glue supply unit to the outer peripheral surface of the glue application roller 123Xa while holding the constant supply amount. Then the glue A is applied to the glue application region PA of the envelope form PE conveyed by the press roller 123Xc, while being pressed against the glue application roller 123Xa.

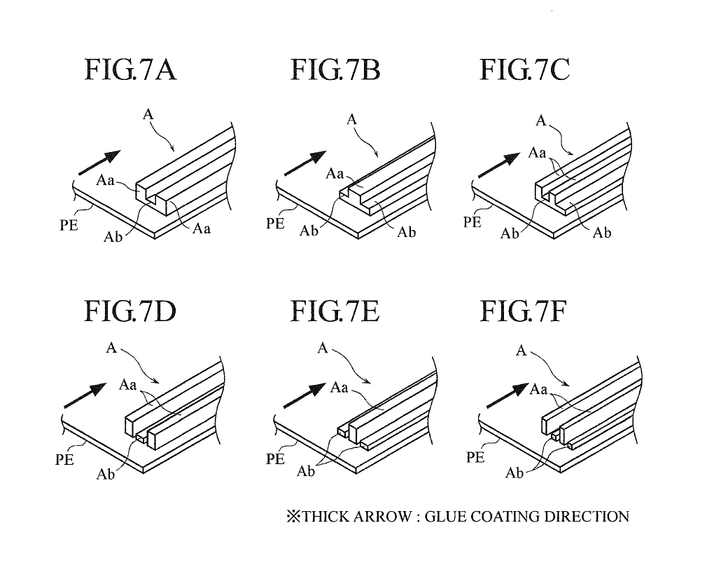

Each configuration example of the glue A applied by the glue application unit 123X will be described referring to FIGS. 7A to 7F.

The application configuration of the glue A to be described below is a mere example, and similar effects may be derived from arbitrary configuration which allows the glue A applied to the glue application region PA to form the main adhesive part Aa and the temporary adhesive part Ab so as to perform the respective functions after the sheet bonding process. Actually, viscosity or surface tension of the glue A may cause the applied glue A to have a slightly rounded corner part. This seems to have negligible impact if the glue A applied to the glue application region PA with difference in the thickness (for example, the thickness of the main adhesive part is three times larger than that of the temporary adhesive part Ab) at least allows both parts to perform the respective functions.

Each application configuration of the glue A as shown in FIGS. 7A to 7C is derived from integrally forming the main adhesive part Aa and the temporary adhesive part Ab. More specifically, FIG. 7A shows the configuration having the temporary adhesive part Ab extending along the glue application direction between the extending main adhesive parts Aa along the same glue application direction, which are integrally formed to have a recess-like cross section orthogonal to the glue application direction. FIG. 7B shows the configuration having the main adhesive part Aa extending along the glue application direction between the extending temporary adhesive parts Ab along the same glue application direction, which are integrally formed to have a convex-like cross section orthogonal to the glue application direction. FIG. 7C shows the configuration having the main adhesive parts Aa and the temporary adhesive parts Ab extending along the same glue application direction, which are alternately disposed to have an F-like cross section orthogonal to the glue application direction.

Each application configuration of the glue A as shown in FIGS. 7D to 7F is derived from forming the main adhesive part Aa and the temporary adhesive part Ab which are apart from a predetermined distance. The predetermined distance is set to be equal to or greater than the thickness (the thickness obtained immediately after the application) of the glue A applied to form the main adhesive part Aa. More specifically, FIG. 7D shows the application configuration having the temporary adhesive part Ab separately disposed along the glue application direction between the two separate main adhesive parts Aa applied along the glue application direction, which are in parallel with one another. FIG. 7E shows the application configuration having the main adhesive part Aa separately disposed along the glue application direction between the two separate temporary adhesive parts Ab applied along the same glue application direction, which are in parallel with one another. FIG. 7F shows the application configuration having the two main adhesive parts Aa and the two temporary adhesive parts Ab formed along the glue application direction, which are alternately disposed in parallel with one another.

Referring to FIGS. 7A to 7F, the glue A is applied by the glue application unit 123X to the glue application region PA of the envelope form PE to form the main adhesive part Aa and the temporary adhesive part Ab. The glue A is applied to form the main adhesive part Aa with the thickness (amount) required to have the glue application region PA and the counter region PB firmly adhered after the sheet bonding process. The glue A is also applied to form the temporary adhesive part Ab with the thickness thinner than the one applied to form the main adhesive part Aa by a predetermined height so that the glue application region PA and the counter region PB are temporarily adhered in a short time immediately after the sheet bonding process. During the sheet bonding process performed by the sheet bonding unit 125 in the subsequent stage, the temporary adhesive part Ab becomes temporarily adhesive within a short period of time so as to prevent peeling off the adhesive part resulting from the bulge of the content P and restoring force of the folded part. After the sheet bonding process, the main adhesive part Aa firmly adheres to secure the adhesive strength to the degree sufficient to withstand impact during transportation.

The ratio between the main adhesive part Aa and the temporary adhesive part Ab formed by the glue A applied to the glue application region PA varies with contents of the job including components of the glue A to be used, size of the envelope form PE, and conditions for manufacturing the envelope as the finished product such as the number of sheets of the content P and the number of folds. It is preferable to select such ratio in accordance with the job corresponding to the sealed letter manufactured at the highest frequency. The application configuration may be selected in accordance with the sealed letter to be manufactured, and the predetermined application groove 123Xd may be formed on the outer surface of the glue application roller 123Xa at the position in contact with the glue application region PA so as to establish the selected configuration.

The sheet bonding unit 125 has a pair of press-fit rollers 125a as the press-fit unit for press-fitting the glue application region PA and the counter region PB of the envelope form PE which are in contact with each other under a predetermined pressure. In response to the incoming content P enclosed in the envelope form PE having the glue application region PA and the counter region PB facing each other, the sheet bonding unit 125 subjects those opposite regions to the press-fitting process under the predetermined applied pressure. The glue application region PA and the counter region PB are then adhered together.

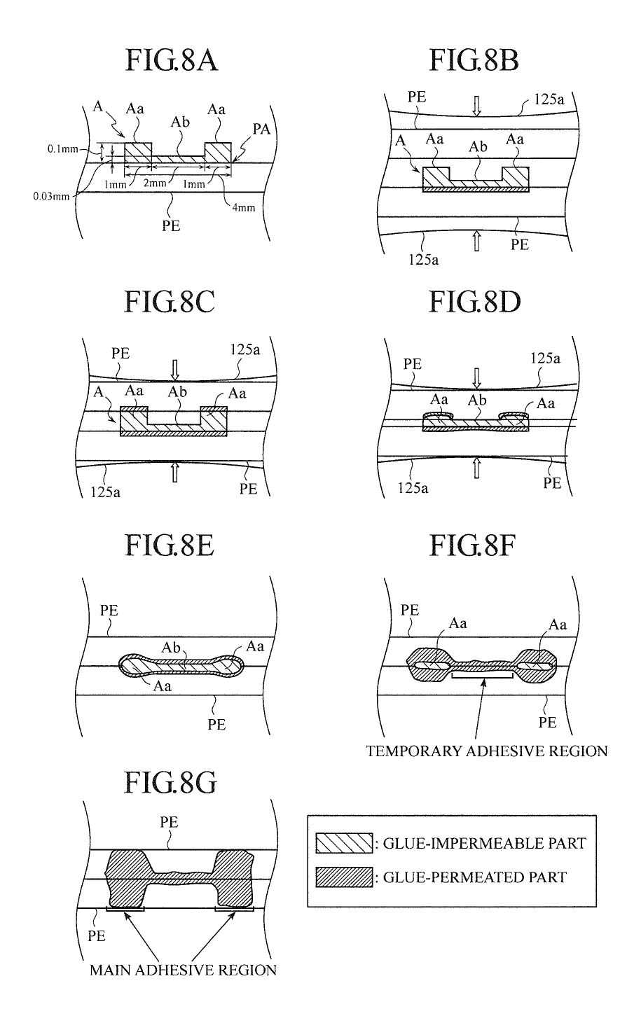

Transformation of the configuration and adhesive states of the glue A in the sheet bonding process will be described referring to FIGS. 8A to 8G. In this case, the W/O emulsion type adhesive is used as the glue A which is applied to the glue application region PA of the envelope form PE to form the configuration having the recess-like cross section orthogonal to the glue application direction.

The drawings lack consistency of the configuration and scale of the envelope form PE and the glue A for easy understanding of the state of the glue A. For the thickness of the glue A, each thickness of the main adhesive part Aa and the temporary adhesive part Ab formed by the glue A applied to the glue application region PA is set to 0.1 mm and 0.03 mm respectively so that the main adhesive part Aa has the thickness three times as large as that of the temporary adhesive part Ab. Each length in the width direction of the main adhesive part Aa and the temporary adhesive part Ab orthogonal to the application direction is set to 1 mm and 2 mm, that is, 4 mm in total. The diameter of the press-fit roller 125a is set to 060 mm.

After the glue A is applied to the glue application region PA as shown in FIG. 8A, the envelope form PE with the glue application region PA and the counter region PB facing each other is conveyed to the sheet bonding unit 125 as shown in FIG. 8B, which starts the sheet bonding process. The glue A applied to the glue application region PA starts permeating the sheet gradually as shown in FIG. 8B.

As the press-fit roller 125a proceeds the gradual press-fitting in the sheet bonding process while keeping the glue application region PA and the counter region PB in contact with each other, permeation of the glue A is further facilitated as shown in FIGS. 8C and 8D. The press-fitted glue A has its configuration varied to a certain degree when it permeates into the fiber of the sheet. The glue applied to form the main adhesive part Aa and the temporary adhesive part Ab permeates while keeping the difference in the thickness between those parts. Thereafter, the sheet adhesive process ends when the glue application region PA and the counter region PB are completely in contact with each other as shown in FIG. 8E.

When the sheet bonding process ends, the temporary adhesive part Ab permeates before the main adhesive part Aa completely permeates as shown in FIG. 8F so that the glue application region PA and the counter region PB are temporarily adhered. The amount of the glue A applied to form the temporary adhesive part Ab is smaller than that of the glue applied to form the main adhesive part Aa. The time taken for the temporary adhesive part Ab to develop the adhesive force is shorter than that for the main adhesive part Aa. The resultant adhesive strength is rather weak, but sufficient to prevent peeling off the adhesive part resulting from the bulge of the enclosed content P and the restoring force of the folded part.

Referring to FIG. 8G, after elapse of the predetermined time from the sheet bonding process performed by the sheet bonding unit 125, the glue A of the main adhesive part Aa completely permeates the envelope form PE. Then the glue application region PA and the counter region PB are firmly adhered. Since the amount of the glue A applied to form the main adhesive part Aa is larger than that of the glue A applied to form the temporary adhesive part Ab, the time taken for the main adhesive part Aa to develop the adhesive force is longer than that of the temporary adhesive part Ab, but the adhesive strength becomes higher. This secures the adhesive strength sufficient to withstand impact during transportation when the sealed letter is completed as the finished product.

In reference to the example as described above, the press-fit roller 125a has the diameter of φ 60 mm in comparison with the thickness (0.1 mm) of the glue applied to the glue application region PA to form the main adhesive part Aa and the thickness (0.03 mm) of the glue applied to form the temporary adhesive part Ab, resulting in the dimensional tolerance as much as several hundred times, approximately. The above-structured device gradually press-fits the glue application region PA with the press-fit roller 125a as the envelope form PE is conveyed. However, the thickness of the glue A of the glue application region PA is negligibly smaller than the diameter of the press-fit roller 125a. Therefore, the glue A applied to form the main adhesive part Aa on the glue application region PA is subjected to the press-fitting process by the press-fit roller 125a in the direction vertical to the surface of the envelope form PE, and permeates the sheet before it reaches the temporary adhesive part Ab.

The storage unit 127 includes various types of storage devices, for example, semiconductor memory of various types, that is, nonvolatile memory such as EEPROM and flash memory, volatile memory such as DRAM and SDRAM, and a storage device of various types such as HDD, and stores information for performing the drive control of the respective components that constitute the sheet bonding device 1.

The control unit 128 includes processors such as CPU (Central Processing Unit), ROM (Read Only Memory), RAM (Random Access Memory), or MPU (Micro-Processing Unit) with the aforementioned functions, and performs drive control of the respective components that constitute the sheet bonding device 1 in accordance with various kinds of drive control information stored in the storage unit 127.

The processing operation performed by the aforementioned sheet bonding device 1 will be described. As described above, the description will be made with respect to the glue application process and the sheet bonding process executed for manufacturing the sealed letter under predetermined conditions, which are performed by such device installed in the enclosing-sealing unit 120.

Start of manufacturing the sealed letter in accordance with the sealed letter manufacturing job information activates the printing unit 110 to start the desired printing process to the envelope form PE and the content P. When the printing process ends, the printed envelope form PE and the printed content P are conveyed from the printing unit 110 to the enclosing-sealing unit 120. A branching unit separates the contents P and the envelope forms PE so as to be fed to the predetermined conveyance paths, respectively.

The envelope form PE that has been separated and conveyed to the conveyance path for envelope form is further conveyed to the glue application unit 123X by the sheet conveyance unit 122 at predetermined timing. After the glue A is applied to the glue application region PA to form the predetermined configuration, it is conveyed to the container unit 124. The content P that has been separated and conveyed to the conveyance path for content is subjected to a predetermined folding process as necessary by the content folding unit 121, and then conveyed to the container unit 124.

The content P is enclosed with the envelope form PE in the enfolding manner by the container unit 124, and conveyed to the sheet bonding unit 125 while keeping the enclosed state. At this time, the glue application region PA and the counter region PB of the envelope form PE face each other.

The sheet bonding unit 125 subjects the glue application region PA and the counter region PB of the conveyed envelope form PE, which are in contact with each other to the press-fitting process so that those regions are adhered. Manufacture of the envelope having the content P enclosed with the envelope form PE is completed.

The sequentially conveyed envelope forms PE are subjected to the glue application process, and the glue application region PA and the counter region PB are press-fitted and adhered to manufacture the sealed letter which encloses the contact P.

As described above, the sheet bonding device 1 according to the first embodiment is configured to apply the glue A to the glue application region PA of the envelope form PE by the glue application unit 123X so as to form the main adhesive part Aa with the thickness required to allow firm adhesion between the glue application region PA and the counter region PB after the sheet bonding process, and the temporary adhesive part Ab with the thickness thinner than that of the main adhesive part Aa by the predetermined height to allow temporary adhesion between the glue application region PA and the counter region PB within a short period of time immediately after the sheet bonding process. The sheet bonding unit 125 applies a predetermined pressure to the envelope form PE having the content P enclosed therein while holding the glue application region PA and the counter region PB in contact with each other for adhesion to execute sealing. Manufacture of the sealed letter is then completed.

The temporary adhesive part Ab temporarily adheres within a short period immediately after the sheet bonding process by sheet bonding unit 125 to prevent peeling off the adhesive part, resulting from bulge of the content and restoring force of the folded part, and the main adhesive part Aa firmly adheres to impart the adhesive strength to the finished product after the sheet bonding process, which is sufficient to withstand impact during transportation.

The glue application unit 123X includes the glue application roller 123Xa which is configured to apply the glue A to the glue application region PA of the envelope form PE to form the main adhesive part Aa and the temporary adhesive part Ab with arbitrary configuration, and the supply amount adjustment roller 123Xb for supplying constant amount of the glue A to the outer peripheral surface of the glue application roller 123Xa. The glue application unit 123X apply the glue A to the glue application region PA in the manner similar to the printing process.

Use of the glue application roller 123Xa with the application groove 123Xd corresponding to the application configuration allows application of the glue A to the glue application region PA with desired application configuration stably without the need for complex control.

### Other Embodiments

The present invention is not limited to the aforementioned embodiment, and may be implemented through modification as appropriate in accordance with the usage environment as described below. It is to be noted that the following modified examples may be arbitrarily combined within the scope of the present invention.

The present invention has been described with respect to the glue application unit 123X configured to apply the glue A to the glue application region PA of the envelope form PE in the manner similar to the printing process using the glue application roller 123Xa having the application groove 123Xd corresponding to the arbitrarily set application configuration of the glue A, and the supply amount adjustment roller 123Xb. However, the structure is not limited to the aforementioned example. The glue application unit 123X of the device may be configured to apply the glue at least to form the main adhesive part Aa and the temporary adhesive part Ab on the glue application region PA of the envelope form PE. Therefore, similar effects to those of the example may be obtained from the structure which employs the known glue application unit such as the dispenser to apply the glue A to form the set application configuration. It is possible to store the glue application configuration information including the set application configuration of the glue A preliminarily in the storage unit 127, and to allow the control unit 128 to apply the glue A to the glue application region PA of the envelope form PE in accordance with the glue application configuration information stored in the storage unit 127.

The device that uses the dispenser to implement the method of applying the glue A may be structured as described below.

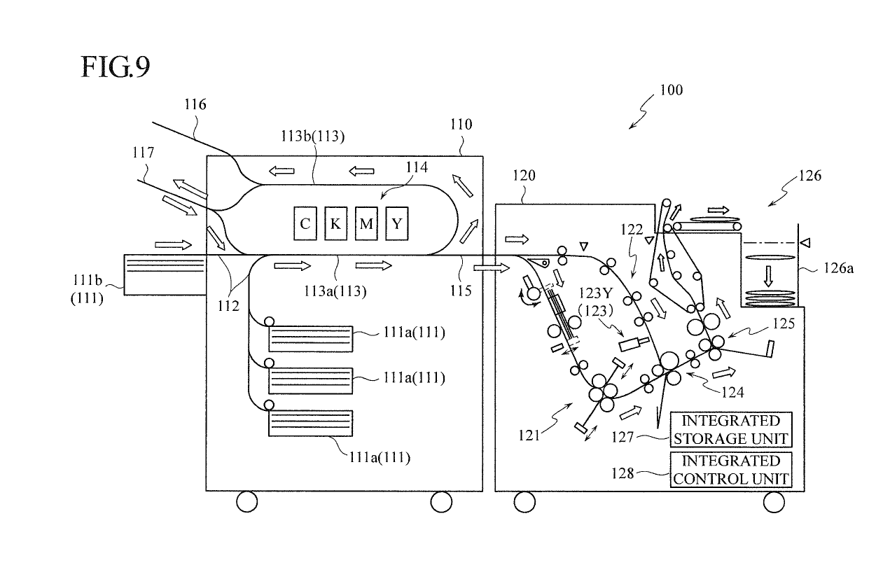

An example of the sheet bonding device 1 provided with a glue application unit 123Y of dispenser type will be described referring to FIGS. 9 to 15B.

The sheet bonding device 1 according to the embodiment will be described with respect only to the featured components by omitting explanations of the components with the same codes as those of the corresponding sheet bonding device 1 with the roller type glue application unit 123X as described above.

The sealed letter manufacturing apparatus 100 in which the dispenser type sheet bonding device 1 (hereinafter simply referred to as “sheet bonding device 1”) is installed will be described.

As FIG. 9 shows, basic structures of the printing unit 110 and the enclosing-sealing unit 120 are the same as those of the sealed letter manufacturing apparatus 100 in which the roller type sheet bonding device 1 is installed. The apparatus of dispenser type is different from that of roller type in that the conveyance path for content for conveying the content P is positioned in the enclosing-sealing unit 120 at the lower side, the conveyance path for envelope form for conveying the envelope form PE is disposed above the conveyance path for content in the enclosing-sealing unit 120, and further the glue application unit 123Y of dispenser type is disposed on the conveyance path for envelope form.

If structures of the sheet bonding device 1 of roller type are the same as those of the sheet bonding device 1 of dispenser type, the sheet bonding device 1 of roller type causes the glue A stored by a given amount between the glue application roller 123Xa and the supply amount adjustment roller 123Xb to run down. It is therefore configured to exchange positions of the conveyance paths for content and the envelope form in the vertical direction in the enclosing-sealing unit 120 as shown in FIG. 1. In this example, however, use of the glue application unit 123Y of dispenser type allows application of the glue A to the envelope form PE even if the glue application unit 123Y is disposed at the descending position of the conveyance path for envelope form as shown in FIG. 9.

The sheet bonding device 1 of this embodiment has the glue application unit 123Y of dispenser type which can be arbitrarily assembled irrespective of position of the conveyance paths in the enclosing-sealing unit 120, resulting in the highly versatile device. The device can be installed in any type of the sealed letter manufacturing apparatus as shown in FIG. 1 or 9.

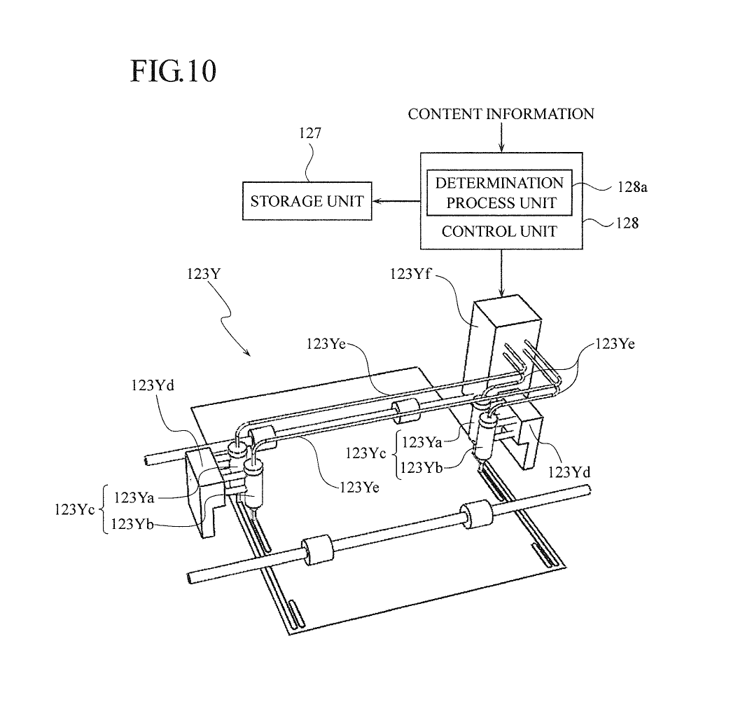

The structure of the sheet bonding device 1 will be described. The sheet bonding device 1 includes the sheet conveyance unit 122, the glue application unit 123Y, the sheet bonding unit 125, the storage unit 127, and the control unit 128 as FIG. 9 or 10 shows. The difference between the device of dispenser type and the one of roller type will only be described.

The glue application unit 123Y includes an application unit 123Yc with a first dispenser 123Ya for applying the glue to form the main adhesive part Aa and a second dispenser 123Yb for applying the glue to form the temporary adhesive part Ab as shown in FIG. 10, by which the main adhesive part Aa and the temporary adhesive part Ab are formed on the respective areas of the glue application region PA of the envelope form PE. Referring to the drawing, application units 123Yc of the glue application unit 123Y are provided to face two glue application regions PA formed at both ends of the envelope form PE. The application unit 123Yc is supported by a support member 123Yd, as the dispensers (123Ya, 123Yb) are configured to move forward and backward in the width direction of the envelope form PE. It is movable in accordance with the width of the envelope form PE and the position of the glue application region PA.

The application unit 123Yc are connected to a compressor 123Yf via air tube 123Ye which supplies compressed air for applying the glue A under the control of the control unit 128 so that the predetermined amount of the glue A is applied.

The process of applying the glue A performed by the glue application unit 123Y of dispenser type will be described.

In this embodiment, the glue application region of the temporary adhesive part Ab (temporary application region PC) in the glue application region PA is appropriately selected in accordance with the thickness, the number of sheets, and the fold type of the content P so that the glue is applied to form the temporary adhesion part Ab.

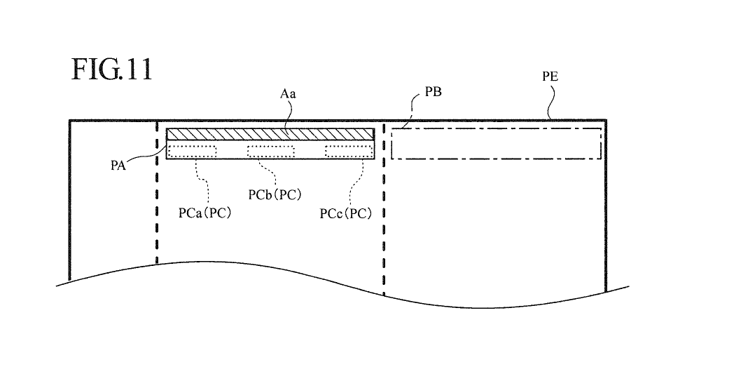

FIG. 11 shows the application area of the temporary adhesive part Ab to which the glue is applied for making the envelope form PE fed in the sheet bonding device 1 inner three-folded. The position of the temporary application region PC (PCa to PCc) is selected in accordance with the position where the folded part of the content P is bulged, and the thickness of the bulged part. A broken line on the right denotes the valley fold for making the folded part with the counter region PB adhered to the glue application region PA, and a broken line on the left denotes the valley fold for making the folded part into the flap.

The temporary application region PC is formed at a distance equal to or greater than the thickness (the thickness obtained immediately after application) of the glue A applied to form the main adhesive part Aa from the application position of the main adhesive part Aa.

The aforementioned arrangement is made in order to prevent the glue for forming the main adhesive part Aa from reaching the temporary adhesive part Ab during adhesion through the press-fitting process between the glue application region PA and the counter region PB by the sheet bonding unit 125. In the glue application region PA, the glue is applied to the main adhesive part Aa along the side edge of the envelope form PE, and the glue is applied to form the temporary adhesive part Ab in the temporary application region PC selected in accordance with the thickness, the number of sheets, and the fold type of the content PC.

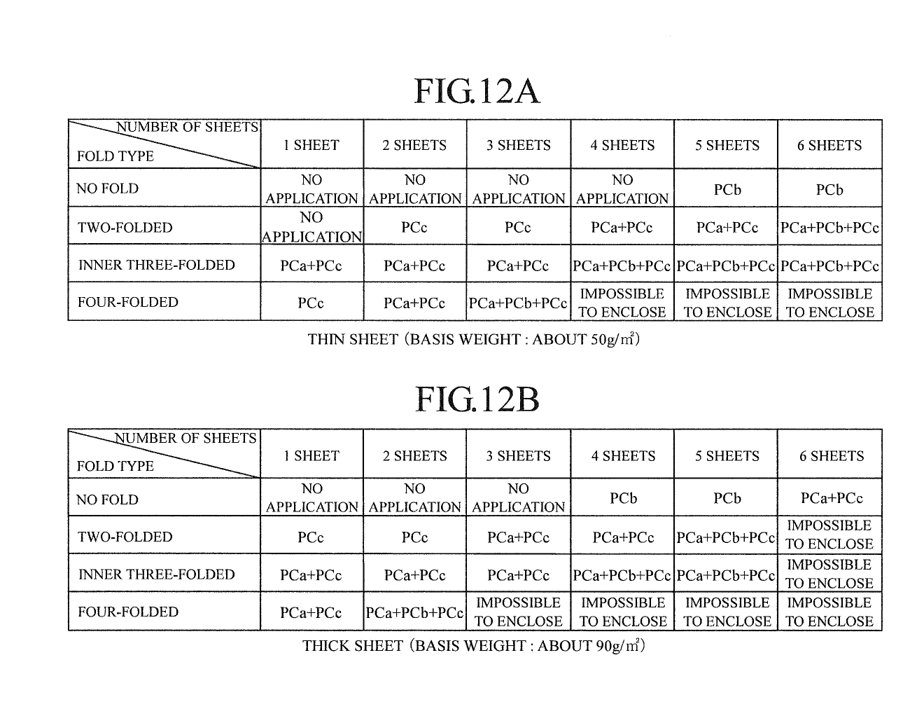

FIGS. 12A and 12B show examples of temporary application region selection table related to the application position of the temporary application region PC selected in accordance with the number of sheets of the content P (1 to 6 sheets in the table) and the fold type (no fold, two-folded, inner three-folded, four-folded in the table) for each thickness information per a sheet of the content P contained in the content information for the sealed letter manufacturing job (in this case, basis weight of a thin sheet of paper is set to about 50 g/m², basis weight of a thick sheet of paper is set to about 90 g/m²).

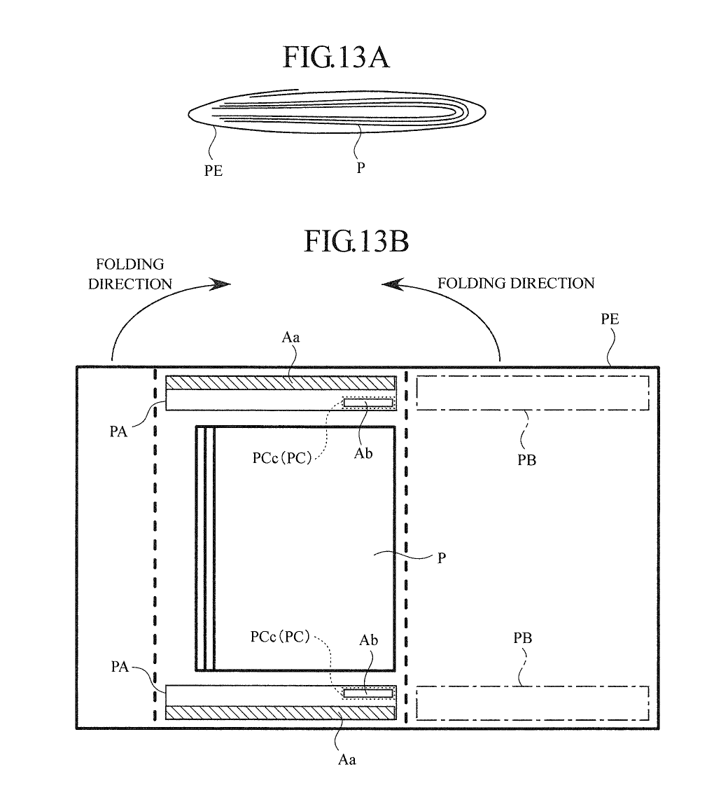

If the content P includes “3” thin sheets of paper which is “two-folded”, the right folded part of the content P is bulged as shown in FIG. 13A. In the case where the envelope form PE is adhered by the sheet bonding unit 125, the adhesive part is likely to be peeled off owing to the thickness of the bulged part. Referring to FIG. 13B, in consideration of the position at which the folded part is bulged, the temporary application region PCc corresponding to conditions of the content P is selected from the temporary application region selection table shown in FIG. 12A so that the glue is applied to this region to form the temporary adhesive part Ab. This makes it possible to prevent peeling off the adhesive part resulting from the bulged part of the content P.

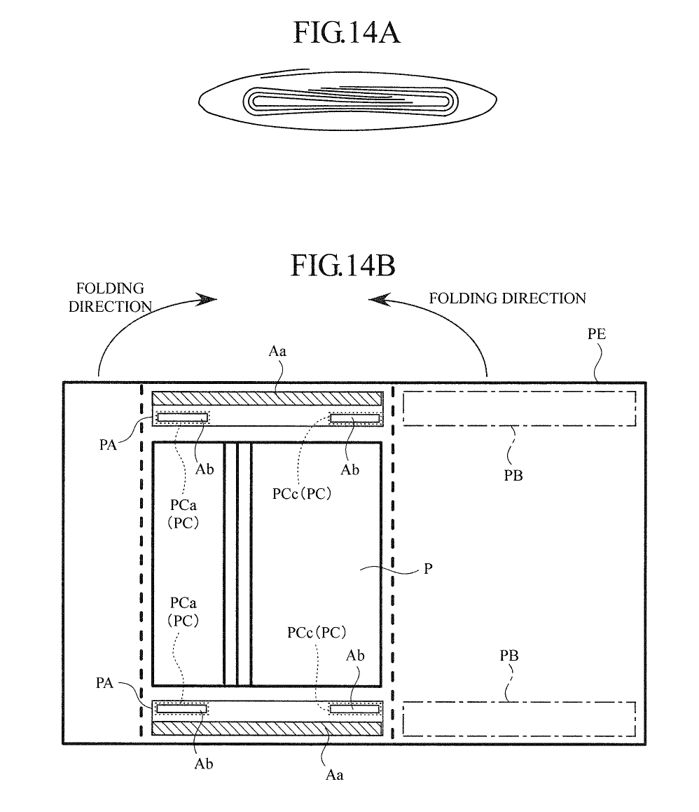

If the content P includes “3” thin sheets of paper, which is “inner three-folded”, left and right folded parts of the content P are bulged as shown in FIG. 14A. In the case where the envelope form PE is adhered by the sheet bonding unit 125, the adhesive part is likely to be peeled off owing to the thickness of the bulged part. Referring to FIG. 14B, in consideration of the position at which the folded part is bulged, the temporary application regions PCa and PCc corresponding to the conditions of the content P are selected from the temporary application region selection table shown in FIG. 12B so that the glue is applied to those regions to form the temporary adhesive part Ab. This makes it possible to prevent peeling off the adhered part resulting from the bulged part of the content P.

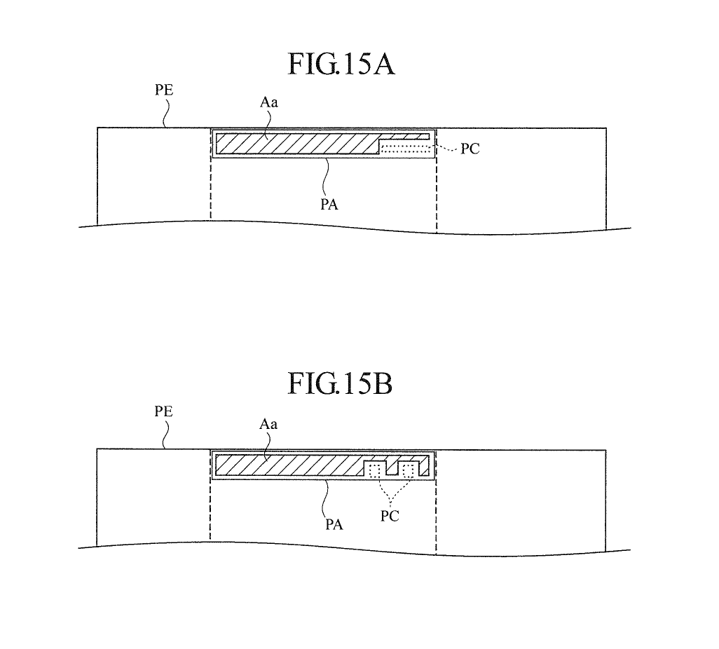

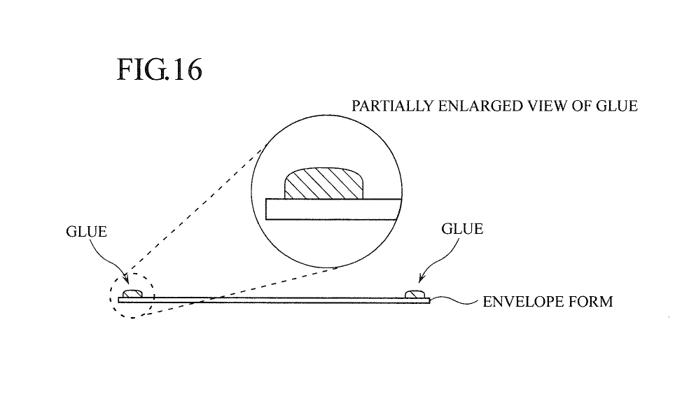

The glue A applied by the glue application unit 123Y may form the main adhesive part Aa and the temporary adhesive part Ab to have uniform belt-like configurations in the glue application region PA as shown in FIG. 11. Additionally, the application surface of the main adhesive part Aa may be partially cut to which the glue is applied to form the temporary adhesive part Ab as shown in FIG. 15A, and a recess is partially formed in the application surface of the main adhesive part Ab to which the glue is applied to form the temporary adhesive part Ab in gaps of the recess part as shown in FIG. 15B.

Referring to FIGS. 12A and 12B, the storage unit 127 stores the content information indicating the thickness, the number of sheets, and the fold type of the content P, which is contained in the sealed letter manufacturing job, and the temporary application region selection tables, which correlate the content information. In the temporary application region selection tables, the temporary application region PC is selected in accordance with the content information. The unit also stores the drive control program required for applying the glue A to form the temporary adhesive part Ab to the temporary application region PC selected from the temporary application region selection table.

The control unit 128 performs drive control of the respective components that constitute the sheet bonding device 1 in accordance with contents of the sealed letter manufacturing job, and the drive control program stored in the storage unit 127.

The control unit 128 includes a determination process unit 128a which allows the glue application unit 123Y to perform the glue application process as shown in FIGS. 13B and 14B in accordance with the content information contained in the sealed letter manufacturing job.

The determination process unit 128a collates the content information contained in the sealed letter manufacturing job and the temporary application region selection table stored in the storage unit 127 so as to determine with respect to necessity of the temporary application part Ab, and selection of the appropriate application position and the number of application of the temporary adhesive part Ab in accordance with the thickness of the bulge of the folded part of the content P. The determination process unit 128a controls the glue application unit 123Y to apply the glue to form the temporary adhesive part Ab to the position of the temporary application region PC selected from the temporary application region selection table.

In this embodiment, the glue is applied to form the temporary adhesive part Ab in accordance with the thickness of the bulge of the folded part of the content P. This ensures to prevent peeling off the adhesive part owing to the bulge of the content P during the process of manufacturing the sealed letter, or immediately after the process, which is performed by the sealed letter manufacturing apparatus 100.

The processing operation performed by the sheet bonding device 1 of dispenser type as aforementioned will be described. The description will be made with respect to the glue application process and the sheet bonding process in the case where this device is installed in the enclosing-sealing unit 120 for manufacturing the sealed letter under predetermined conditions.

At the start of manufacturing the sealed letter in accordance with the sealed letter manufacturing job, the printing unit 110 starts executing the desired printing process to the envelope form PE and the content P. Upon completion of the printing process, the printed envelope form PE and the printed content P are conveyed from the printing unit 110 to the enclosing-sealing unit 120. Then the branching unit sorts the content P and the envelope form PE, which will be separated and fed to the respective conveyance paths.

The envelope form PE which has been separated and conveyed to the conveyance path for envelope form is conveyed to the glue application unit 123Y by the sheet conveyance unit 122 at predetermined timing. The glue A is applied to the glue application region PA to form a predetermined application configuration. Then it is conveyed to the container unit 124. When the glue A is applied to the glue application region PA, the control unit 128 collates the content information of the content P enclosed in the sealed letter and the temporary application region table stored in the storage unit 127 to select the temporary application region PC corresponding to the sealed letter to be manufactured. The control unit controls the glue application unit 123Y so that the position and the number of applications of the temporary adhesive part Ab become suitable for the sealed letter to be manufactured. In this way, the main adhesive part Aa and the temporary adhesive part Ab are appropriately formed in the glue application region PA of the envelope form PE.

The content P which has been separated and conveyed to the conveyance path for content is folded into a predetermined fold type by the content folding unit 121 as necessary. It is then conveyed to the container unit 124 where the content P is enclosed with the envelope form PE in the enfolding manner, which will be conveyed to the sheet bonding unit 125 as they are. At this time, the glue application region PA and the counter region PB of the envelope form PE face each other.

The sheet bonding unit 125 applies the press-fitting process to the glue application region PA and the counter region PB of the conveyed envelope form PE, which are in contact with each other so as to be adhered. Thus the sealed letter, whose content P is enclosed with the envelope form PE, is completed.

The sealed letter is manufactured by performing the glue application process to the sequentially fed envelope form PE, and the press-fitting process to the glue application region PA and the counter region PB so as to be adhered together while keeping the content P enclosed.

As described above, the sheet bonding device 1 provided with the glue application unit 123Y of dispenser type as described above controls the glue application unit 123Y so that the main adhesive part Aa and the temporary adhesive part Ab are formed in the glue application region PA of the envelope form PE by selecting the temporary application region PC in accordance with the sealed letter to be manufactured by collating the content information of the content P enclosed in the sealed letter to be manufactured and the temporary application region table stored in the storage unit 127.

Therefore, it is possible to apply the glue to form arbitrary numbers of the main adhesive parts Aa and the temporary adhesive parts Ab to arbitrary positions in the glue application region PA, for example, as shown in FIGS. 13A to 14B. It is also possible to apply the glue to form the temporary adhesive part Ab in the temporary application region PC corresponding to the thickness (especially the thickness of the folded part) of the content P defined by the thickness, the number of sheets, and the fold type of the content P. This makes it possible to save consumption amount of the glue A.

In the aforementioned embodiments, the glue application unit 123 of roller type or dispenser type is configured to manufacture the sealed letter by enclosing the content P with the envelope form PE in the enfolding manner. Therefore the explanation is made with respect to the structure having the glue application region PA and the counter region PB formed on the envelope form PE. However, the present invention is not limited to the examples as described above. If the envelope form PE and another sheet (an adhered sheet) are to be adhered, the sheet bonding unit 125 may be configured to manufacture the sealed letter by bringing the glue application region PA of the envelope form PE and the counter region PB of another sheet to be adhered into contact with each other, and performing the press-fitting process to those sheets so as to be adhered.

In the example, the sealed letter is manufactured through adhesion of the envelope form PE that encloses the content P that is folded into the arbitrary fold type. Depending on the size, the content P is not folded so as to be enclosed as it is. Alternatively, the content P does not have to be enclosed if the predetermined printing is applied to the inner surface of the envelope form PE.

Besides the example using the ink jet recording device as the printing unit 110 for the printer, it is possible to employ various types of image forming devices such as the stencil printer, copying machine, laser printer in addition to the ink jet recording device so long as the desired image is formed on the sheet to be formed as the content P or the envelope form PE in accordance with the type of the sealed letter to be manufactured.

The embodiments have been described with respect to the sealed letter manufacturing apparatus 100 configured to connect the printing unit 110 and the enclosing-sealing unit 120 so as to manufacture the sealed letter through execution of the printing process and the enclosing-sealing process in succession to the non-printed content P and the non-printed envelope form PE. However, the present invention is not limited to the structure as described above. The sealed letter manufacturing apparatus 100 may be configured to connect the sheet feeder in place of the printing unit 110, which contains the content P and the envelope form PE which have already been printed in a predetermined manner to the enclosing-sealing unit 120.

In the embodiments, the integrated storage unit 127 and the integrated control unit 128 are installed in the enclosing-sealing unit 120 as show in FIG. 1 or FIG. 9. However, those units may be installed either in the printing unit 110 or the enclosing-sealing unit 120 which constitutes the sealed letter manufacturing apparatus 100. Functions of those units may be imparted to the external terminal unit such as PC (personal computer) so as to execute the drive control by receiving and transmitting the control signals of the respective components of the enclosing-sealing unit 120 from and to the external terminal unit.

1. A sheet bonding device comprising:
a glue application unit for applying glue to glue application region of a sheet; and
a sheet bonding unit for adhering the glue application region to which glue is applied and counter region to be adhered to the glue application region, which are in contact with each other through application of a predetermined pressure,
wherein the glue application unit applies glue to the glue application region of the sheet to form main adhesive part having a thickness which ensures to keep an adhesive state between the glue application region and the counter region after an adhesion process performed by the sheet bonding unit, as well as temporary adhesive part having a thickness thinner than the thickness of the main adhesive part for temporary adhesion.

2. The sheet bonding device according to claim 1, wherein the glue application unit forms the temporary adhesive part, which has a thickness half or smaller than the thickness of the main adhesive part, at a position away more than distance corresponding to the thickness of the main adhesive part, which is measured at immediately after applying the glue, from an application position of the main adhesive part.

3. The sheet bonding device according to claim 1, wherein the glue application unit includes a glue application roller with an application groove formed to allow each of the main adhesive part and the temporary adhesive part to have a predetermined thickness upon application of glue to the glue application region of the sheet.

4. The sheet bonding device according to claim 2, wherein the glue application unit includes a glue application roller with an application groove formed to allow each of the main adhesive part and the temporary adhesive part to have a predetermined thickness upon application of glue to the glue application region of the sheet.

5. The sheet bonding device according to claim 1, wherein the glue application unit includes a first dispenser for forming the main adhesive part, a second dispenser for forming the temporary adhesive part, and a control unit for controlling glue application operations of the first and the second dispensers.

6. The sheet bonding device according to claim 2, wherein the glue application unit includes a first dispenser for forming the main adhesive part, a second dispenser for forming the temporary adhesive part, and a control unit for controlling glue application operations of the first and the second dispensers.

7. An enclosing-sealing device which uses the sheet bonding device according to claim 1 for applying glue to glue application region of an envelope form and manufacturing a sealed matter by adhering the glue application region with counter region of the envelope form while having a content enclosed with the envelope form to which the glue is applied, and sealing the envelope form, wherein the temporary adhesive part is formed to have a belt-like configuration shorter than the main adhesive part, and has its application position and total number of applications controlled in accordance with a thickness of the sealed matter.

8. An enclosing-sealing device which uses the sheet bonding device according to claim 2 for applying glue to glue application region of an envelope form and manufacturing a sealed matter by adhering the glue application region with counter region of the envelope form while having a content enclosed with the envelope form to which the glue is applied, and sealing the envelope form, wherein the temporary adhesive part is formed to have a belt-like configuration shorter than the main adhesive part, and has its application position and total number of applications controlled in accordance with a thickness of the sealed matter.

9. An enclosing-sealing device which uses the sheet bonding device according to claim 5 for applying glue to glue application region of an envelope form and manufacturing a sealed matter by adhering the glue application region with counter region of the envelope form while having a content enclosed with the envelope form to which the glue is applied, and sealing the envelope form, wherein the temporary adhesive part is formed to have a belt-like configuration shorter than the main adhesive part, and has its application position and total number of applications controlled in accordance with a thickness of the sealed matter.

10. An enclosing-sealing device which uses the sheet bonding device according to claim 6 for applying glue to glue application region of an envelope form and manufacturing a sealed matter by adhering the glue application region with counter region of the envelope form while having a content enclosed with the envelope form to which the glue is applied, and sealing the envelope form, wherein the temporary adhesive part is formed to have a belt-like configuration shorter than the main adhesive part, and has its application position and total number of applications controlled in accordance with a thickness of the sealed matter.
